(19) United States
(12) Patent Application Publication
(10) Pub. No.: US 2025/0187636 A1
(43) Pub. Date: Jun. 12, 2025

(54) ARRANGEMENT FOR EQUIPOTENTIAL BONDING OF A SUPPORT CABLE OF A CABLEWAY

(71) Applicant: Innova Patent GmbH, Wolfurt (AT)

(72) Inventors: Dietmar FESSLER, Langen bei Bregenz (AT); Marcel KECKEIS, Dornbirn (AT); Peter LUGER, Dornbirn (AT)

(73) Assignee: Innova Patent GmbH, Wolfurt (AT)

(21) Appl. No.: 18/971,652

(22) Filed: Dec. 6, 2024

(30) Foreign Application Priority Data
Dec. 7, 2023 (AT) A50990/2023

(51) Int. Cl. B61B 12/02; B61B 12/06; H05F 3/02

(52) U.S. Cl. CPC B61B 12/02; B61B 12/06; H05F 3/02

(57) ABSTRACT

An arrangement for equipotential bonding of a support cable of a cableway that does not lose its effect even in the event of possible slight movements of the support cable. The arrangement includes an insert recess on the plastics material insert of a guide part for the support cable, through which insert recess an electrically conductive contact element is inserted, and the contact element is movably arranged in the insert recess. A spring element is provided that presses the electrically conductive contact element against the support cable so that the electrically conductive contact element contacts the support cable guided on the plastics material insert with a contact surface. The electrically conductive contact element is electrically connected to an equipotential bonding point of the cableway.

### CROSS-REFERENCE TO RELATED APPLICATION

This application claims priority under 35 U.S.C. § 119(a) to Austria Application No. A50990/2023 filed Dec. 7, 2023, the disclosure of which is expressly incorporated by reference herein in its entirety.

### BACKGROUND

### 1. Field of the Invention

Embodiments relate to an arrangement for equipotential bonding of a support cable of a cableway, a guide part being arranged on a stationary device of the cableway, the guide part comprising a plastics material insert extending in cable direction and the support cable resting and being guided on the plastics material insert.

### 2. Discussion of Background Information

Cableways use cables, usually made of steel or a combination of steel and plastics, to move cable cars, usually between two or more cableway stations. A cableway cable can be designed as a support cable and can be firmly tensioned between two points, for example two cableway stations. A cableway cable can also be designed as a haulage cable and can be moved, either back and forth or to rotate. For example, cable cars are moved using a haulage cable, for example by clamping the cable car firmly or detachably to the haulage cable. When using at least one support cable, the cable cars run over rollers on at least one support cable and are moved by a haulage cable connected to the cable car. In a cableway, a haulage cable and, if necessary, a support cable are guided over aerial lift pylons arranged between the cableway stations.

For safety reasons, the cables of a cableway must be electrically grounded for equipotential bonding in order to safely discharge any possible electrical charge on the cable, for example due to electrostatic charging, lightning strikes, coupling of electrical currents through electrical fields, etc. In principle, an electrical charge can occur on the cable even if the cable itself is not electrically conductive. Such equipotential bonding to a defined reference potential, for example ground, is easier to achieve with tightly tensioned support cables than with moving haulage cables, because there is no or only very little relative movement between the support cable and the grounding. However, with moving haulage cables, equipotential bonding is difficult because the moving cable must be safely and permanently electrically contacted for equipotential bonding. Due to the relative movements, there is also high wear on the contact element that contacts the haulage cable. In order to reduce wear, WO 2022/090166 A1, the disclosure of which is expressly incorporated by reference herein in its entirety, proposes a contact brush with bristles made of electrically conductive plastics material as a contact element.

WO 2018/150149 A1, the disclosure of which is expressly incorporated by reference herein in its entirety, discloses a grounding of a haulage or support cable of a cableway in which a contact element having a spring is pressed against the cable in order to establish a secure electrical contact between the contact element and the cable. This grounding is also subject to considerable wear in the case of a moving haulage cable, which is further increased by the high contact forces due to the spring preload, making this grounding poorly suited for moving cables. Although the spring preload of the contact element can improve the electrical contact, the cable of a cableway can deviate sideways due to external influences, such as wind forces, cable vibrations, etc. This applies to both haulage cables and the support cables of a cableway. In the event of a lateral deflection, the electrical contact and thus the equipotential bonding could be lost or at least impaired, despite the spring preload of the contact element. This means that under certain circumstances the grounding of the support cable is not satisfactorily resolved.

A support cable of a cableway can rest on or be attached to an electrically conductive and grounded component of the cableway, such as an aerial lift pylon, which would also ensure equipotential bonding. However, such equipotential bonding can be lost due to movement of the support cable caused by external influences, such as wind forces, cable vibrations, etc., which leads to incorrect positioning of the support cable. A holding device of a support cable on a component of a cableway is described, for example, in EP 2 127 990 B1, the disclosure of which is expressly incorporated by reference herein in its entirety.

However, the support cables of a cableway are increasingly being embedded in guide parts with plastic inserts because this reduces the mechanical load acting on the support cable and reduces the wear and tear on the support cable. If the support cable is embedded on a plastics material insert, equipotential bonding via the contact to the guide part would not be possible.

### SUMMARY

Embodiments of the present invention provide safer electrical equipotential bonding of a support cable of a cableway, which does not lose its effectiveness even in the event of possible slight movements of the support cable.

According to embodiments, an insert recess is provided on the plastics material insert, through which insert recess an electrically conductive contact element is inserted, and the contact element is movably arranged in the insert recess. A spring element is further provided that presses the electrically conductive contact element against the support cable so that the electrically conductive contact element contacts the support cable guided on the plastics material insert with a contact surface. The electrically conductive contact element is electrically connected to an equipotential bonding point of the cableway.

Once the support cable is guided and held in the plastics material insert, there is generally no lateral movement (perpendicular to the cable direction) of the support cable during operation. Small movements in cable direction are possible due to stretching or load changes in the support cable. Such movements of the support cable in the cable direction do not affect the contact between the support cable and the contact element. This results in only minimal relative movements between the support cable and the contact element, so wear on the contact element is also small. More importantly, however, the spring-loaded contact element, which extends into the plastics material insert, can compensate also for small possible movements of the support cable transverse to the cable direction and, also with such movements, a secure electrical contact for equipotential bonding can always be ensured. Equipotential bonding is thus always ensured during the usual and expected movements of the support cable during operation of the cableway.

To protect the plastics material insert, the guide part can comprise a guide housing in which the plastics material insert is arranged. In this case, a housing recess is provided on the guide housing, and the electrically conductive contact element is pushed through the housing recess in the guide housing and through the insert recess in the plastics material insert.

The guide housing is preferably detachably mounted on the stationary device of the cableway. This allows the guide housing to be easily replaced, for example if the plastics material insert is worn. Of course, only the plastics material insert could be replaceable.

Other exemplary embodiments and advantages of the present invention may be ascertained by reviewing the present disclosure and the accompanying drawing.

### BRIEF DESCRIPTION OF THE DRAWINGS

The present invention is described in greater detail below with reference to FIGS. 1 to 6, which show schematic and non-limiting advantageous embodiments of the invention by way of example. In the figures:

FIG. 1 shows a section of a cableway with a support cable and a guide part;

FIGS. 2 to 4 are different views of a guide part according to the invention with a contact element;

FIG. 5 shows a guide part with a plurality of contact elements; and

FIG. 6 shows a guide part with a transport lock for the contact element.

### DETAILED DESCRIPTION

The particulars shown herein are by way of example and for purposes of illustrative discussion of the embodiments of the present invention only and are presented in the cause of providing what is believed to be the most useful and readily understood description of the principles and conceptual aspects of the present invention. In this regard, no attempt is made to show structural details of the present invention in more detail than is necessary for the fundamental understanding of the present invention, the description taken with the drawings making apparent to those skilled in the art how the several forms of the present invention may be embodied in practice.

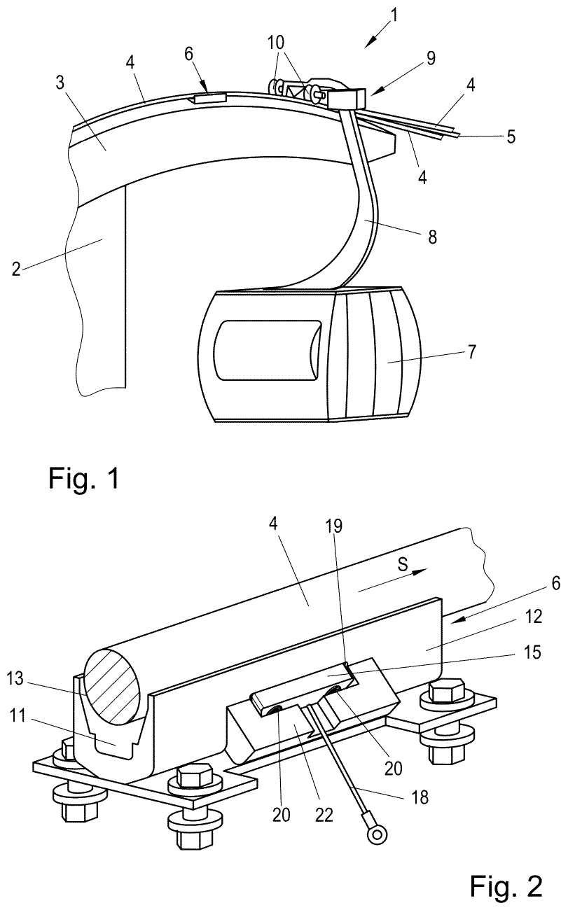

FIG. 1 schematically shows a small section of a cableway 1 with an aerial lift pylon 2 with a cable support 3 which is arranged on the aerial lift pylon 2. The aerial lift pylon 2 and the cable support 3 are stationary devices of the cableway 1. At least one support cable 4 of the cableway 1 runs on the cable support 3. In the embodiment according to FIG. 1, two support cables 4 are provided, although more or fewer (at least one) support cable(s) 4 can be provided. For this purpose, the support cable 4 is guided, for example, on the upper side of the cable support 3, as in the embodiment according to FIG. 1. For this purpose, a guide part 6 is also arranged on the cable support 3, in which guide part the support cable 4 is guided and held.

A cable car 7 has a running gear 9 having a number of running rollers 10. The running gear 9 is connected to a transport part, for example a gondola, of the cable car 7 via a suspension rod 8. When the cable car 7 moves, the number of running rollers 10 rolls on the support cable 4, or optionally on different support cables 4. To move the cable car 7, a traction cable 5 is provided, which runs, for example, between two cableway stations (not shown). The support cable 4 is usually tensioned between the two cableway stations. The running gear 9 generally comprises a known cable clamp for clamping the cable car 7 to the traction cable 5 by the cable clamp or for releasing it therefrom (for example, in a cableway station).

An embodiment of a guide part 6 according to the invention is shown in FIGS. 2 to 4. The guide part 6 comprises a plastics material insert 11 extending in the cable direction S (the longitudinal direction of the support cable 4). When the guide part 6 is being used, the support cable 4 rests on the plastics material insert 11. The plastics material insert 11 holds and guides the support cable 4. The support cable 4 is tensioned between two points in the cableway 1. The support cable 4 therefore moves only to a very limited extent, for example due to external influences, such as wind or cable vibrations or when a cable car 7 passes by. In any case, the support cable 4 is not rotated due to a cableway drive and is also not moved back and forth by a cableway drive.

The plastics material insert 11 is advantageously designed on the side facing the support cable 4 with a guide groove 13 extending in the cable direction S in which the support cable 4 comes to lie. The guide groove 13 allows the support cable 4 to be held and guided better and more safely.

In the embodiments shown in FIGS. 2 to 4, the guide part 6 also comprises a guide housing 12 for receiving the plastics material insert 11. The plastics material insert 11 is arranged in the guide housing 12. The guide housing 12 is designed, for example, in the form of a U-shaped profile, the plastics material insert 11 being arranged between the two legs of the U-shaped profile. The guide housing 12 can have any suitable shape. However, the guide housing 12 is optional and does not necessarily have to be present.

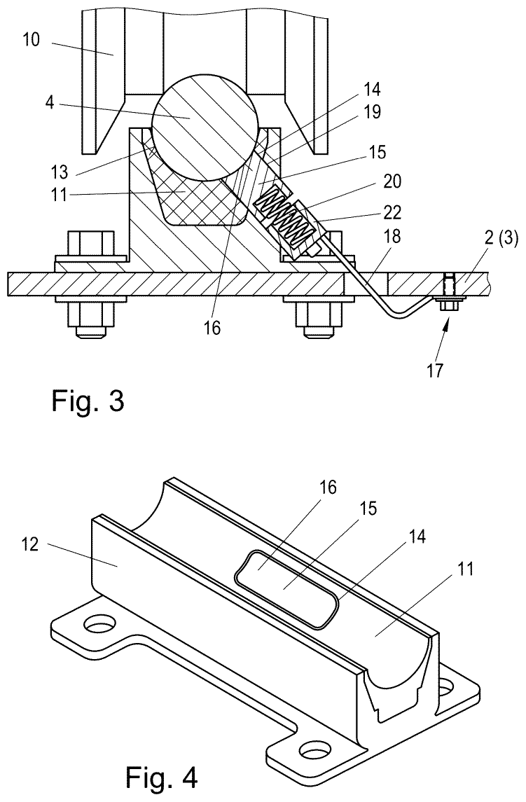

In the embodiment according to FIG. 2, the plastics material insert 11, or the guide housing 12 having the plastics material insert 11, is arranged to be movable, in this case pivotable, for example as described in EP 2 127 990 B1. This does not necessarily have to be the case either, as shown for example in FIG. 3.

Because the plastics material insert 11 is made of plastic, the support cable 4 is electrically insulated from other components of the cableway 1 by the plastics material insert 11. In order to nevertheless allow for electrical equipotential bonding of the support cable 4, an insert recess 14 is provided on the plastics material insert 11. An electrically conductive contact element 15 is inserted through the insert recess 14. In this case, the contact element 15 extends into the region of the plastics material insert 11, for example into the region of the guide groove 13, in which region the support cable 4 comes to rest during use. Thus, the support cable 4 guided on the plastics material insert 11 is electrically contacted by the electrically conductive contact element 15. For this purpose, the contact element 15 has a contact surface 16 that touches the support cable 4. The electrically conductive contact element 15 is electrically connected to an equipotential (ground) bonding point 17 (for example on the aerial lift pylon 2) of the cableway 1. The electrical connection can be made via an electrical connection cable 18, as in the embodiments shown.

The contact element 15 is designed, for example, as an electrically conductive carbon brush or a brush having electrically conductive plastic bristles. Instead of a brush, the contact element 15 can of course also be designed as a rigid electrically conductive component, for example as a graphite block.

If the plastics material insert 11 is arranged in a guide housing 12, then a housing recess 19 is also provided in the guide housing 12, through which the electrically conductive contact element 15 is inserted. In this case, the recess 14 in the plastics material insert 11 and the housing recess 19 in the guide housing 12 are aligned and the contact element 15 is pushed through both.

The contact element 15 is arranged in the insert recess 14, and optionally also in the housing recess 19, so as to be movable in the direction toward the support cable 4. The contact element 15 is therefore expediently also arranged to be movable in the direction away from the support cable 4.

Furthermore, a spring element 20, for example a spiral spring or a leaf spring, is provided on the guide part 6, which spring element 20 presses the electrically conductive contact element 15 against the support cable 4 located in the plastics material insert 11. This establishes and maintains electrical contact.

Due to the spring-loaded contact element 15, the electrical contact between the support cable 4 in the plastics material insert 11 and the contact element 15 can be maintained even if the support cable 4 moves due to external influences. The fixedly tensioned support cable 4 will move only slightly during operation of the cableway 1. The spring-loaded contact element 15 can at least compensate for this movement in order to maintain electrical contact and thus equipotential bonding. In the event of a serious fault, for example where the support cable 4 completely jumps out of the plastics material insert 11, the equipotential bonding could not be ensured. However, such errors must be intercepted in some other way anyway, for example as in EP 2 127 990 B1.

A spring holder 22 can be arranged on the guide housing 12 or another component of the guide part 6, and the spring element 20 can be arranged between the spring holder 22 and the contact element 15.

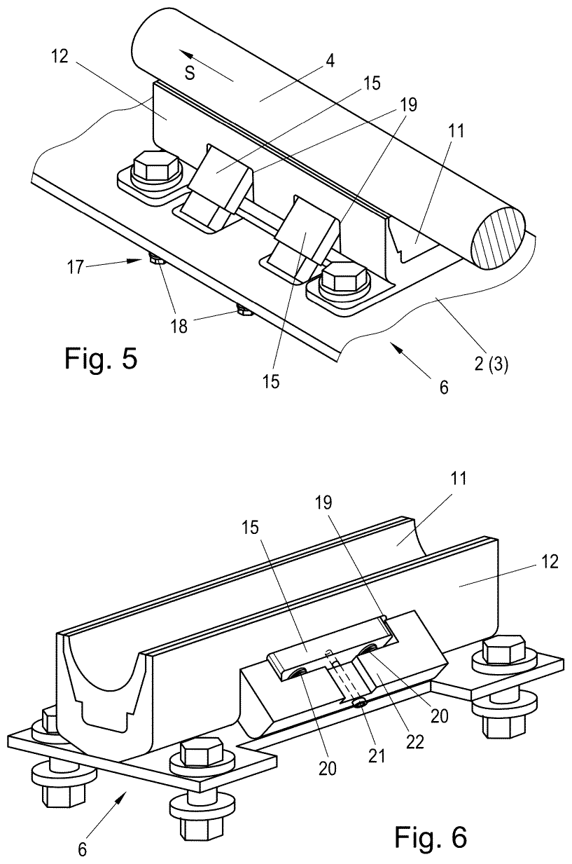

A plurality of contact elements 15 can also be arranged on the guide part 6, distributed over the cable direction S, as shown in FIG. 5. Each of these contact elements 15 can be connected to an equipotential bonding point 17 of the cableway 1, or to different equipotential bonding points 17 of the cableway 1.

In the embodiment according to FIG. 6, a transport lock 21 is provided on the guide part 6, for example on the spring holder 22. In this case, the transport lock 21 is designed as a screw, it also being possible for the transport lock to be designed in any other way. The transport lock 21 is detachably connected to the contact element 15 and holds the contact element 15 in a defined position retracted from the support cable 4 during use. This allows the support cable 4 to be arranged in the plastics material insert 11 before the spring element 20 presses the electrically conductive contact element 15 against the support cable 4 after the transport lock 21 has been released. At the same time, this can prevent the contact element 15 from falling out of the guide part 6, for example, during installation or maintenance.

It is noted that the foregoing examples have been provided merely for the purpose of explanation and are in no way to be construed as limiting of the present invention. While the present invention has been described with reference to an exemplary embodiment, it is understood that the words which have been used herein are words of description and illustration, rather than words of limitation. Changes may be made, within the purview of the appended claims, as presently stated and as amended, without departing from the scope and spirit of the present invention in its aspects. Although the present invention has been described herein with reference to particular means, materials and embodiments, the present invention is not intended to be limited to the particulars disclosed herein; rather, the present invention extends to all functionally equivalent structures, methods and uses, such as are within the scope of the appended claims.

What is claimed:

1. An arrangement for equipotential bonding of a support cable of a cableway, comprising:
a guide part, which is arranged on a stationary device of the cableway, comprising a plastics material insert extending in a cable direction with a surface to receive and guide the support cable;
an electrically conductive contact element, wherein the plastics material insert includes an insert recess through which the electrically conductive contact element is insertable and movably arranged; and
a spring element arranged to press the electrically conductive contact element against the support cable, whereby a contact face of the electrically conductive contact element contacts the support cable guided on the plastics material insert,
wherein the electrically conductive contact element is electrically connected to an equipotential bonding point of the cableway.

2. The arrangement according to claim 1, wherein the guide part further comprises a guide housing in which the plastics material insert is arranged, the guide housing having a housing recess arranged for the electrically conductive contact element to be pushed through the housing recess and through the insert recess.

3. The arrangement according to claim 2, wherein a spring holder is arranged on the guide housing, and
wherein the spring element is arranged between the spring holder and the contact element.

4. The arrangement according to claim 2, wherein the guide housing is detachably arranged on the stationary device of the cableway.

5. The arrangement according to claim 1, wherein the guide part further comprises a transport lock, which is detachably connectable to the contact element and holds the contact element in a defined position retracted from the support cable, while the support cable is being arranged in the plastics material insert.

6. The arrangement according to claim 5, wherein the transport lock is structured to be released after the support cable is arranged in the plastics material insert, whereby the spring element presses the electrically conductive contact element against the support cable.
